(19) United States
(12) Patent Application Publication
(10) Pub. No.: US 2025/0277169 A1
(43) Pub. Date: Sep. 4, 2025

(54) AQUEOUS DETERGENT FORMULATION

(71) Applicants: Dow Global Technologies LLC, Midland, MI (US); Rohm and Haas Company, Collegeville, PA (US)

(72) Inventors: Matthew Carter, Bala Cynwyd, PA (US); Graham P. Abramo, Penllyn, PA (US); Aslin Izmitli, Spring City, PA (US); Ligeng Yin, Collegeville, PA (US); Robert David Grigg, Midland, MI (US); Meng Jing, Collegeville, PA (US); James Defelippis, Perkiomenville, PA (US); Scott Backer, Phoenixville, PA (US); Lyndsay M. Leal, Spring City, PA (US)

(21) Appl. No.: 18/857,199

(22) PCT Filed: May 22, 2023
(86) PCT No.: PCT/US2023/023036

§ 371 Date: Oct. 16, 2024

Related U.S. Application Data
(60) Provisional application No. 63/345,045, filed on May 24, 2022.

(51) Int. Cl. C11D 3/37; C08F 218/08; C08F 218/14

(52) U.S. Cl. CPC C11D 3/3753; C08F 218/08; C08F 218/14; C08F 2810/20

(57) ABSTRACT

A laundry detergent formulation is provided including an aqueous carrier; a cleaning surfactant; a thickening polymer, comprising: 20-80 wt %, based on dry weight of the thickening polymer, of structural units of a monoethylenically unsaturated vinyl alkanoate having 4-12 carbon atoms; 20-80 wt %, based on dry weight of the thickening polymer, of structural units of a monoethylenically unsaturated carboxylic acid functionalized vinyl ester having 4-12 carbon atoms; 0-5 wt %, based on dry weight of the thickening polymer, of structural units of a multiethylenically unsaturated crosslinker; 0-20 wt %, based on dry weight of the thickening polymer, of structural units of an other monoethylenically unsaturated monomer; and wherein the thickening polymer contains <10 wt %, based on dry weight of the thickening polymer, of structural units of a monoethylenically unsaturated dicarboxylic acid having 4-6 carbon atoms, alkali metal salts thereof, ammonium salts thereof and mixtures thereof.

The present invention relates to an aqueous detergent formulation. In particular, the present invention relates to an aqueous detergent formulation, comprising: an aqueous carrier; a cleaning surfactant and a thickening polymer, comprising 20 to 80 wt %, based on dry weight of the thickening polymer, of structural units of a monoethylenically unsaturated vinyl alkanoate having 4 to 12 carbon atoms; 20 to 80 wt %, based on dry weight of the thickening polymer, of structural units of a monoethylenically unsaturated carboxylic acid functionalized vinyl ester having 4 to 12 carbon atoms; 0 to 5 wt %, based on dry weight of the thickening polymer, of structural units of a multiethylenically unsaturated crosslinker; 0 to 20 wt %, based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; and wherein the thickening polymer contains less than 10 wt %, based on dry weight of the thickening polymer, of structural units of a monoethylenically unsaturated dicarboxylic acid having 4 to 6 carbon atoms, alkali metal salts thereof, ammonium salts thereof and mixtures thereof.

Aqueous detergent formulations are well known. Notwithstanding, conventional aqueous detergent formulations often comprise a variety of nonbiodegradable ingredients including thickeners. There is a desire in the marketplace to increase the biodegradable content of aqueous detergent formulations, in particular aqueous laundry detergent formulations. Many conventional thickeners used in aqueous detergent formulations include alkali soluble/swellable latexes, which while not toxic and not posing serious hazards to the environment, are typically not biodegradable.

Accordingly, there remains a need to find new biodegradable ingredients suitable for use as thickeners in aqueous detergent formulations.

The present invention provides an aqueous detergent formulation, comprising: an aqueous carrier; a cleaning surfactant and a thickening polymer, comprising: 20 to 80 wt %, based on dry weight of the thickening polymer, of structural units of a monoethylenically unsaturated vinyl alkanoate having 4 to 12 carbon atoms; 20 to 80 wt %, based on dry weight of the thickening polymer, of structural units of a monoethylenically unsaturated carboxylic acid functionalized vinyl ester having 4 to 12 carbon atoms; 0 to 5 wt %, based on dry weight of the thickening polymer, of structural units of a multiethylenically unsaturated crosslinker; 0 to 20 wt %, based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; and wherein the thickening polymer contains less than 10 wt %, based on dry weight of the thickening polymer, of structural units of a monoethylenically unsaturated dicarboxylic acid having 4 to 6 carbon atoms, alkali metal salts thereof, ammonium salts thereof and mixtures thereof.

### DETAILED DESCRIPTION

Applicants have surprisingly found that aqueous detergent formulations comprising an aqueous carrier and a cleaning surfactant can be effectively thickened using a thickening polymer, comprising 20 to 80 wt %, based on dry weight of the thickening polymer, of structural units of a monoethylenically unsaturated vinyl alkanoate having 4 to 12 carbon atoms; 20 to 80 wt %, based on dry weight of the thickening polymer, of structural units of a monoethylenically unsaturated carboxylic acid functionalized vinyl ester having 4 to 12 carbon atoms; 0 to 5 wt %, based on dry weight of the thickening polymer, of structural units of a multiethylenically unsaturated crosslinker; 0 to 20 wt %, based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; and wherein the thickening polymer contains less than 10 wt %, based on dry weight of the thickening polymer, of structural units of a monoethylenically unsaturated dicarboxylic acid having 4 to 6 carbon atoms, alkali metal salts thereof, ammonium salts thereof and mixtures thereof; wherein the thickening polymer exhibits biodegradability following the procedure of OECD 302B.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polystyrene standards. GPC techniques are discussed in detail in Modem Size Exclusion Chromatography, W. W. Yau, J. J. Kirkland, D. D. Bly; Wiley-lnterscience, 1979, and in A Guide to Materials Characterization and Chemical Analysis, J. P. Sibilia; VCH, 1988, p. 81-84. Weight average molecular weights are reported herein in units of Daltons.

Preferably, the aqueous detergent formulation of the present invention is selected from the group consisting of an aqueous laundry detergent formulation, an aqueous dish detergent formulation and an aqueous hand soap formulation. More preferably, the aqueous detergent formulation of the present invention is an aqueous laundry detergent formulation.

Preferably, the aqueous detergent formulation of the present invention, comprises: an aqueous carrier (preferably, 15 to 97.9 wt % (preferably, 40 to 94.75 wt %; more preferably, 45 to 92 wt %; most preferably, 47 to 89 wt %), based on weight of the aqueous detergent formulation, of the aqueous carrier); a cleaning surfactant (preferably, 2 to 60 wt % wt % (preferably, 5 to 40 wt %; more preferably, 7.5 to 30 wt %; most preferably, 10 to 25 wt %), based on weight of the aqueous detergent formulation, of the cleaning surfactant); a thickening polymer (preferably, 0.1 to 7.5 wt % (preferably, 0.25 to 6 wt %; more preferably, 0.5 to 5 wt %; most preferably, 1 to 3 wt %), based on weight of the aqueous detergent formulation, of the thickening polymer), comprising: 20 to 80 wt % (preferably, 24.89 to 77.89 wt %; more preferably, 39.48 to 74.48 wt %; most preferably, 43.96 to 71.46 wt %), based on dry weight of the thickening polymer, of structural units of a monoethylenically unsaturated vinyl alkanoate having 4 to 12 carbon atoms; 20 to 80 wt % (preferably, 22 to 75 wt %; more preferably, 25 to 60 wt %; most preferably, 27.5 to 55 wt %), based on dry weight of the thickening polymer, of structural units of a monoethylenically unsaturated carboxylic acid functionalized vinyl ester having 4 to 12 carbon atoms; 0 to 5 wt % (preferably, 0.01 to 2.5 wt %; more preferably, 0.02 to 1 wt %; most preferably, 0.04 to 0.5 wt %), based on dry weight of the thickening polymer, of structural units of a multiethylenically unsaturated crosslinker; 0 to 20 wt % (preferably, 0.1 to 5 wt %; more preferably, 0.5 to 4 wt %; most preferably, 1 to 3 wt %), based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; and wherein the thickening polymer contains less than 10 wt % (preferably, <5 wt %; more preferably, <1 wt %; still more preferably, <0.1 wt %; most preferably, <detectable limit), based on dry weight of the thickening polymer, of structural units of a monoethylenically unsaturated dicarboxylic acid having 4 to 6 carbon atoms, alkali metal salts thereof, ammonium salts thereof and mixtures thereof.

Preferably, the aqueous detergent formulation of the present invention, comprises 15 to 97.9 wt % (preferably, 40 to 94.75 wt %; more preferably, 45 to 92 wt %; most preferably, 47 to 89 wt %), based on weight of the aqueous detergent formulation, of an aqueous carrier. More preferably, the aqueous detergent formulation of the present invention comprises 15 to 97.9 wt % (preferably, 40 to 94.75 wt %; more preferably, 45 to 92 wt %; most preferably, 47 to 89 wt %), based on weight of the aqueous detergent formulation, of an aqueous carrier; wherein the aqueous carrier comprises water. Most preferably, the aqueous detergent formulation of the present invention comprises 15 to 97.9 wt % (preferably, 40 to 94.75 wt %; more preferably, 45 to 92 wt %; most preferably, 47 to 89 wt %), based on weight of the aqueous detergent formulation, of an aqueous carrier; wherein the aqueous carrier comprises deionized water.

Preferably, the aqueous carrier in the aqueous detergent formulation of the present invention can include a water miscible liquid, such as, C₁₋₃ alkanolamine, C₁₋₃ alkanol, C₁₋₃ alkane diol and mixtures thereof. More preferably, the aqueous carrier in the aqueous detergent formulation of the present invention includes 0 to 8 wt % (preferably, 0.2 to 8 wt %; more preferably, 0.5 to 5 wt %), based on weight of the aqueous carrier, of a water miscible liquid; wherein the water miscible liquid is selected from the group consisting of a C₁₋₃ alkanolamine, a C₁₋₃ alkanol, a C₁₋₃ alkane diol and mixtures thereof. Most preferably, the aqueous carrier in the aqueous detergent formulation of the present invention includes 0 to 8 wt % (preferably, 0.2 to 8 wt %; more preferably, 0.5 to 5 wt %), based on weight of the aqueous carrier, of a water miscible liquid; wherein the water miscible liquid is selected from the group consisting of ethanol, propylene glycol and mixtures thereof.

Preferably, the aqueous detergent formulation of the present invention, comprises 2 to 60 wt % (preferably, 5 to 40 wt %; more preferably, 7.5 to 30 wt %; most preferably, 10 to 25 wt %), based on weight of the aqueous detergent formulation, of a cleaning surfactant. More preferably, the aqueous detergent formulation of the present invention, comprises: 2 to 60 wt % (preferably, 5 to 40 wt %; more preferably, 7.5 to 30 wt %; most preferably, 10 to 25 wt %), based on weight of the aqueous detergent formulation, of a cleaning surfactant; wherein the cleaning surfactant is selected from the group consisting of anionic surfactants, nonionic surfactants, cationic surfactants, amphoteric surfactants and mixtures thereof. Still more preferably, the aqueous detergent formulation of the present invention, comprises: 2 to 60 wt % (preferably, 5 to 40 wt %; more preferably, 7.5 to 30 wt %; most preferably, 10 to 25 wt %), based on weight of the aqueous detergent formulation, of a cleaning surfactant; wherein the cleaning surfactant includes an anionic surfactant. Yet more preferably, the aqueous detergent formulation of the present invention, comprises: 2 to 60 wt % (preferably, 5 to 40 wt %; more preferably, 7.5 to 30 wt %; most preferably, 10 to 25 wt %), based on weight of the aqueous detergent formulation, of a cleaning surfactant; wherein the cleaning surfactant includes a mixture of an anionic surfactant and a nonionic surfactant. Most preferably, the aqueous detergent formulation of the present invention, comprises: 2 to 60 wt % (preferably, 5 to 40 wt %; more preferably, 7.5 to 30 wt %; most preferably, 10 to 25 wt %), based on weight of the aqueous detergent formulation, of a cleaning surfactant; wherein the cleaning surfactant includes a mixture of a linear alkyl benzene sulfonate, a sodium lauryl ethoxysulfate and a nonionic alcohol ethoxylate.

Anionic surfactants include alkyl sulfates, alkyl benzene sulfates, alkyl benzene sulfonic acids, alkyl benzene sulfonates, alkyl polyethoxy sulfates, alkoxylated alcohols, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenols, alkyl phenol polyethoxy ether sulfates, 2-acryloxy-alkane-1-sulfonic acid, 2-acryloxy-alkane-1-sulfonate, beta-alkyloxy alkane sulfonic acid, beta-alkyloxy alkane sulfonate, amine oxides and mixtures thereof. Preferred anionic surfactants include C₈₋₂₀ alkyl benzene sulfates, C₈₋₂₀ alkyl benzene sulfonic acid, C₈₋₂₀ alkyl benzene sulfonate, paraffin sulfonic acid, paraffin sulfonate, alpha-olefin sulfonic acid, alpha-olefin sulfonate, alkoxylated alcohols, C₈₋₂₀ alkyl phenols, amine oxides, sulfonates of fatty acids, sulfonates of fatty acid esters, C₈₋₁₀ alkyl polyethoxy sulfates and mixtures thereof. More preferred anionic surfactants include C₁₂₋₁₆ alkyl benzene sulfonic acid, C₁₂₋₁₆ alkyl benzene sulfonate, C₁₂₋₁₈ paraffin-sulfonic acid, C₁₂₋₁₈ paraffin-sulfonate, C₁₂₋₁₆ alkyl polyethoxy sulfate and mixtures thereof.

Non-ionic surfactants include alkoxylates (e.g., polyglycol ethers, fatty alcohol polyglycol ethers, alkylphenol polyglycol ethers, end group capped polyglycol ethers, mixed ethers, hydroxy mixed ethers, fatty acid polyglycol esters and mixtures thereof. Preferred non-ionic surfactants include fatty alcohol polyglycol ethers. More preferred non-ionic surfactants include secondary alcohol ethoxylates, ethoxylated 2-ethylhexanol, ethoxylated seed oils, butanol caped ethoxylated 2-ethylhexanol and mixtures thereof. Most preferred non-ionic surfactants include secondary alcohol ethoxylates.

Cationic surfactants include quaternary surface active compounds. Preferred cationic surfactants include quaternary surface active compounds having at least one of an ammonium group, a sulfonium group, a phosphonium group, an iodonium group and an arsonium group. More preferred cationic surfactants include at least one of a dialkyldimethylammonium chloride and alkyl dimethyl benzyl ammonium chloride. Still more preferred cationic surfactants include at least one of C₁₆₋₁₈ dialkyldimethylammonium chloride, a C₈₋₁₈ alkyl dimethyl benzyl ammonium chloride and dimethyl ditallow ammonium chloride. Most preferred cationic surfactant includes dimethyl ditallow ammonium chloride.

Amphoteric surfactants include betaines, amine oxides, alkylamidoalkylamines, alkyl-substituted amine oxides, acylated amino acids, derivatives of aliphatic quaternary ammonium compounds and mixtures thereof. Preferred amphoteric surfactants include derivatives of aliphatic quaternary ammonium compounds. More preferred amphoteric surfactants include derivatives of aliphatic quaternary ammonium compounds with a long chain group having 8 to 18 carbon atoms. Still more preferred amphoteric surfactants include at least one of C₁₂₋₁₄ alkyldimethylamine oxide, 3-(N,N-dimethyl-N-hexadecyl-ammonio)propane-1-sulfonate, 3-(N,N-dimethyl-N-hexadecylammonio)-2-hydroxypropane-1-sulfonate. Most preferred amphoteric surfactants include at least one of C₁₂₋₁₄ alkyldimethylamine oxide.

Preferably, the aqueous detergent formulation of the present invention, comprises 0.1 to 7.5 wt % (preferably, 0.25 to 6 wt %; more preferably, 0.5 to 5 wt %; most preferably, 1 to 3 wt %), based on weight of the aqueous detergent formulation, of a thickening polymer, comprising: 20 to 80 wt % (preferably, 24.89 to 77.89 wt %; more preferably, 39.48 to 74.48 wt %; most preferably, 43.96 to 71.46 wt %), based on dry weight of the thickening polymer, of structural units of a monoethylenically unsaturated vinyl alkanoate having 4 to 12 carbon atoms; 20 to 80 wt % (preferably, 22 to 75 wt %; more preferably, 25 to 60 wt %; most preferably, 27.5 to 55 wt %), based on dry weight of the thickening polymer, of structural units of a monoethylenically unsaturated carboxylic acid functionalized vinyl ester having 4 to 12 carbon atoms; 0 to 5 wt % (preferably, 0.01 to 2.5 wt %; more preferably, 0.02 to 1 wt %; most preferably, 0.04 to 0.5 wt %), based on dry weight of the thickening polymer, of structural units of a multiethylenically unsaturated crosslinker; 0 to 20 wt % (preferably, 0.1 to 5 wt %; more preferably, 0.5 to 4 wt %; most preferably, 1 to 3 wt %), based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; and wherein the thickening polymer contains less than 10 wt % (preferably, <5 wt %; more preferably, <1 wt %; still more preferably, <0.1 wt %; most preferably, <detectable limit), based on dry weight of the thickening polymer, of structural units of a monoethylenically unsaturated dicarboxylic acid having 4 to 6 carbon atoms, alkali metal salts thereof, ammonium salts thereof and mixtures thereof.

Preferably, the thickening polymer in the aqueous detergent formulation, of the present invention, comprises: 20 to 80 wt % (preferably, 24.89 to 77.89 wt %; more preferably, 39.48 to 74.48 wt %; most preferably, 43.96 to 71.46 wt %), based on dry weight of the thickening polymer, of structural units of a monoethylenically unsaturated vinyl alkanoate having 4 to 12 carbon atoms; wherein the monoethylenically unsaturated vinyl alkanoate having 4 to 12 carbon atoms is selected from the group consisting of vinyl acetate, vinyl propionate, vinyl butyrate, vinyl isobutyrate, vinyl pentanoate, vinyl 3-methyl butanoate, vinyl pivalate, vinyl hexanoate, vinyl 4-methyl pentanoate, vinyl 3,3-dimethyl butanoate, vinyl heptanoate, vinyl 5-methyl hexanoate, vinyl 4,4-dimethyl pentanoate, vinyl octanoate, vinyl 6-methyl heptanoate, vinyl 5,5-dimethyl hexanoate, vinyl nonanoate, vinyl 7-methyl octanoate, vinyl decanoate, vinyl 8-methyl nonanoate, vinyl 6,6-dimethyl heptanoate, vinyl 2-methyl-2-propylhexanoate, vinyl 2-ethyl-2-methylheptanoate, vinyl 2,2-dimethyloctanoate, vinyl 2,2-dimethylheptanoate, vinyl 2-ethyl-2-methylhexanoate, vinyl 2-methyl-2-propylpentanoate, vinyl 2-ethylhexanoate and mixtures thereof. More preferably, the thickening polymer in the aqueous detergent formulation, of the present invention, comprises: 20 to 80 wt % (preferably, 24.89 to 77.89 wt %; more preferably, 39.48 to 74.48 wt %; most preferably, 43.96 to 71.46 wt %), based on dry weight of the thickening polymer, of structural units of a monoethylenically unsaturated vinyl alkanoate having 4 to 12 carbon atoms; wherein the monoethylenically unsaturated vinyl alkanoate having 4 to 12 carbon atoms is selected from the group consisting of vinyl acetate, vinyl propionate, vinyl butyrate, vinyl isobutyrate, vinyl pentanoate, vinyl 3-methyl butanoate, vinyl pivalate, vinyl hexanoate, vinyl 4-methyl pentanoate, vinyl 3,3-dimethyl butanoate, vinyl heptanoate, vinyl 5-methyl hexanoate, vinyl 4,4-dimethyl pentanoate, vinyl octanoate, vinyl 6-methyl heptanoate, vinyl 5,5-dimethyl hexanoate and mixtures thereof. Still more preferably, the thickening polymer in the aqueous detergent formulation, of the present invention, comprises: 20 to 80 wt % (preferably, 24.89 to 77.89 wt %; more preferably, 39.48 to 74.48 wt %; most preferably, 43.96 to 71.46 wt %), based on dry weight of the thickening polymer, of structural units of a monoethylenically unsaturated vinyl alkanoate having 4 to 12 carbon atoms; wherein the monoethylenically unsaturated vinyl alkanoate having 4 to 12 carbon atoms is selected from the group consisting of vinyl acetate, vinyl propionate, vinyl butyrate, vinyl isobutyrate, vinyl pentanoate, vinyl 3-methyl butanoate, vinyl pivalate, vinyl hexanoate, vinyl 4-methyl pentanoate, vinyl 3,3-dimethyl butanoate and mixtures thereof. Yet more preferably, the thickening polymer in the aqueous detergent formulation, of the present invention, comprises: 20 to 80 wt % (preferably, 24.89 to 77.89 wt %; more preferably, 39.48 to 74.48 wt %; most preferably, 43.96 to 71.46 wt %), based on dry weight of the thickening polymer, of structural units of a monoethylenically unsaturated vinyl alkanoate having 4 to 12 carbon atoms; wherein the monoethylenically unsaturated vinyl alkanoate having 4 to 12 carbon atoms is selected from the group consisting of vinyl acetate, vinyl propionate, vinyl butyrate, vinyl isobutyrate and mixtures thereof. Most preferably, the thickening polymer in the aqueous detergent formulation, of the present invention, comprises: 20 to 80 wt % (preferably, 24.89 to 77.89 wt %; more preferably, 39.48 to 74.48 wt %; most preferably, 43.96 to 71.46 wt %), based on dry weight of the thickening polymer, of structural units of a monoethylenically unsaturated vinyl alkanoate having 4 to 12 carbon atoms; wherein the monoethylenically unsaturated vinyl alkanoate having 4 to 12 carbon atoms is vinyl acetate.

Preferably, the thickening polymer in the aqueous detergent formulation, of the present invention, comprises: 20 to 80 wt % (preferably, 22 to 75 wt %; more preferably, 25 to 60 wt %; most preferably, 27.5 to 55 wt %), based on dry weight of the thickening polymer, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is selected from the group consisting of 2-oxo-2-(vinyloxy)acetic acid, 3-oxo-3-(vinyloxy)propanoic acid, 4-oxo-4-(vinyloxy)butanoic acid (aka vinyl succinic acid), 5-oxo-5-(vinyloxy)pentanoic acid, 6-oxo-6-(vinyloxy)hexanoic acid (aka vinyl adipic acid), 7-oxo-7-(vinyloxy)heptanoic acid, 8-oxo-8-(vinyloxy)octanoic acid, 9-oxo-9-(vinyloxy)nonanoic acid, 10-oxo-10-(vinyloxy)decanoic acid and mixtures thereof. More preferably, the biodegradable thickening polymer in the aqueous detergent formulation, of the present invention, comprises: 20 to 80 wt % (preferably, 22 to 75 wt %; more preferably, 25 to 60 wt %; most preferably, 27.5 to 55 wt %), based on dry weight of the thickening polymer, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is selected from the group consisting of 4-oxo-4-(vinyloxy)butanoic acid, 5-oxo-5-(vinyloxy)pentanoic acid, 6-oxo-6-(vinyloxy)hexanoic acid, 7-oxo-7-(vinyloxy)heptanoic acid, 8-oxo-8-(vinyloxy)octanoic acid and mixtures thereof. Still more preferably, the thickening polymer in the aqueous detergent formulation, of the present invention, comprises: 20 to 80 wt % (preferably, 22 to 75 wt %; more preferably, 25 to 60 wt %; most preferably, 27.5 to 55 wt %), based on dry weight of the thickening polymer, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is selected from the group consisting of 5-oxo-5-(vinyloxy)pentanoic acid, 6-oxo-6-(vinyloxy)hexanoic acid, 7-oxo-7-(vinyloxy)heptanoic acid, 8-oxo-8-(vinyloxy)octanoic acid and mixtures thereof. Yet more preferably, the thickening polymer in the aqueous detergent formulation, of the present invention, comprises: 20 to 80 wt % (preferably, 22 to 75 wt %; more preferably, 25 to 60 wt %; most preferably, 27.5 to 55 wt %), based on dry weight of the thickening polymer, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is selected from the group consisting of 6-oxo-6-(vinyloxy)hexanoic acid, 7-oxo-7-(vinyloxy)heptanoic acid, 8-oxo-8-(vinyloxy)octanoic acid and mixtures thereof. Most preferably, the thickening polymer in the aqueous detergent formulation, of the present invention, comprises: 20 to 80 wt % (preferably, 22 to 75 wt %; more preferably, 25 to 60 wt %; most preferably, 27.5 to 55 wt %), based on dry weight of the thickening polymer, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is 6-oxo-6-(vinyloxy)hexanoic acid.

Preferably, the thickening polymer in the aqueous detergent formulation, of the present invention, comprises: 0 to 5 wt % (preferably, 0.01 to 2.5 wt %; more preferably, 0.02 to 1 wt %; most preferably, 0.04 to 0.5 wt %), based on dry weight of the thickening polymer, of structural units of a multiethylenically unsaturated crosslinker; wherein the multiethylenically unsaturated crosslinker is selected from the group consisting of multiethylenically unsaturated crosslinkers having an average of two or three vinyl groups per molecule. More preferably, the thickening polymer in the aqueous detergent formulation, of the present invention, comprises: 0 to 5 wt % (preferably, 0.01 to 2.5 wt %; more preferably, 0.02 to 1 wt %; most preferably, 0.04 to 0.5 wt %), based on dry weight of the thickening polymer, of structural units of a multiethylenically unsaturated crosslinker; wherein the multiethylenically unsaturated crosslinker is selected from the group consisting of allyl (meth)acrylate, tripropylene glycol di(meth)acrylate, diethylene glycol di(meth)acrylate, ethylene glycol di(meth)acrylate, 1,6-hexanediol di(meth)acrylate, 1,3-butylene glycol di(meth)acrylate, polyalkylene glycol di(meth)acrylate, diallyl phthalate, trimethylolpropane tri(meth)acrylate, divinylbenzene, divinyl toluene, trivinyl benzene, divinyl naphthalene and mixtures thereof. Most preferably, the thickening polymer in the aqueous detergent formulation, of the present invention, comprises: 0 to 5 wt % (preferably, 0.01 to 2.5 wt %; more preferably, 0.02 to 1 wt %; most preferably, 0.04 to 0.5 wt %), based on dry weight of the thickening polymer, of structural units of a multiethylenically unsaturated crosslinker; wherein the multiethylenically unsaturated crosslinker is diallyl phthalate.

Preferably, the thickening polymer in the aqueous detergent formulation, of the present invention, comprises 0 to 20 wt % (preferably, 0.1 to 5 wt %; more preferably, 0.5 to 4 wt %; most preferably, 1 to 3 wt %), based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms and wherein the other monoethylenically unsaturated monomer is selected from the group consisting of alkyl (meth)acrylate, alkyl (meth)acrylamide, vinyl ether, vinyl sulfonic acid, styrene sulfonic acid, acrylamidopropylmethane sulfonic acid, (meth)acrylic acid, maleic acid, salts thereof and mixtures thereof. More preferably, the thickening polymer in the aqueous detergent formulation, of the present invention, comprises 0 to 20 wt % (preferably, 0.1 to 5 wt %; more preferably, 0.5 to 4 wt %; most preferably, 1 to 3 wt %), based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms and wherein the other monoethylenically unsaturated monomer is selected from the group consisting of C₁₋₄ alkyl (meth)acrylate, C₁₋₄ alkyl (meth)acrylamide, vinyl ether, vinyl sulfonic acid, styrene sulfonic acid, acrylamidopropylmethane sulfonic acid, (meth)acrylic acid, maleic acid, salts thereof and mixtures thereof. Still more preferably, the thickening polymer in the aqueous detergent formulation, of the present invention, comprises 0 to 20 wt % (preferably, 0.1 to 5 wt %; more preferably, 0.5 to 4 wt %; most preferably, 1 to 3 wt %), based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms and wherein the other monoethylenically unsaturated monomer is selected from the group consisting of methyl (meth)acrylate, ethyl (meth)acrylate, methyl (meth)acrylamide, ethyl (meth)acrylamide, vinyl ether, vinyl sulfonic acid, styrene sulfonic acid, (meth)acrylic acid, maleic acid, salts thereof and mixtures thereof. Most preferably, the thickening polymer in the aqueous detergent formulation, of the present invention, comprises 0 to 20 wt % (preferably, 0.1 to 5 wt %; more preferably, 0.5 to 4 wt %; most preferably, 1 to 3 wt %), based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms and wherein the other monoethylenically unsaturated monomer is selected from the group consisting of vinyl sulfonic acid, salts of vinyl sulfonic acid and mixtures thereof.

Preferably, the thickening polymer of the present invention contains less than 10 wt % (preferably, <5 wt %; more preferably, <1 wt %, still more preferably, <0.1 wt %; most preferably, <detectable limit), based on dry weight of the thickening polymer, of structural units of monoethylenically unsaturated dicarboxylic acid having 4 to 6 carbon atoms, alkali metal salts thereof, ammonium salts thereof and mixtures thereof.

Preferably, the structural units of monoethylenically unsaturated vinyl alkanoate having 4 to 12 carbon atoms and the structural units of monoethylenically unsaturated carboxylic acid functionalized vinyl ester having 4 to 12 carbon atoms account for a total of 70 to 100 wt % (more preferably, 75 to 100 wt %; still more preferably, 80 to 100 wt %; yet more preferably, 85 to 99.9 wt %; yet still more preferably, 90 to 99.5 wt %; most preferably, 95 to 99 wt %) of the thickening polymer, based on dry weight of the thickening polymer.

Preferably, the thickening polymer of the present invention contains less than 1.2 wt % (preferably, 0 to 1.1 wt %; more preferably, 0 to 1.0 wt %; still more preferably, 0 to 0.5 wt %; yet more preferably, 0 to 0.1 wt %; most preferably, 0 to 0.01 wt %), based on dry weight of the thickening polymer, of structural units of 2-acrylamido-2-methyl-propanesulfonic acid.

Preferably, the thickening polymer of the present invention contains less than 5 mol % (preferably, <1 mol %; more preferably, <0.1 mol %; most preferably, <the detectable limit) of structural units of an anhydride of a dicarboxylic acid. More preferably, the thickening polymer of the present invention contains less than 5 mol % (preferably, <1 mol %; more preferably, <0.1 mol %; most preferably, <the detectable limit) of structural units of an anhydride of a dicarboxylic acid selected from the group consisting of maleic anhydride, itaconic anhydride and mixtures thereof.

Preferably, the thickening polymer of the present invention contains less than 10 wt % (preferably, <5 wt %; more preferably, <1 wt %; still more preferably, <0.1 wt %; most preferably, <detectable limit), based on dry weight of the thickening polymer, of structural units of a monoethylenically unsaturated alkyl acrylate monomer containing 2 to 10 carbon atoms. More preferably, the thickening polymer of the present invention contains less than 10 wt % (preferably, <5 wt %; more preferably, <1 wt %; still more preferably, <0.1 wt %; most preferably, <detectable limit), based on dry weight of the thickening polymer, of structural units of a monoethylenically unsaturated alkyl acrylate monomer containing 2 to 10 carbon atoms selected from the group consisting of methyl acrylate, ethyl acrylate, propyl acrylate, n-butyl acrylate, isobutyl acrylate, 2-ethylhexyl acrylate, methyl methacrylate, ethyl methacrylate, isobutyl methacrylate, 2-ethylhexyl methacrylate and mixtures thereof.

Preferably, the thickening polymer of the present invention contains less than 0.1 mol % (preferably, <0.01 mol %; more preferably, <0.001 mol %; most preferably, <detectable limit) of structural units of a monoethylenically unsaturated amide containing monomer. More preferably, the thickening polymer of the present invention contains less than 0.1 mol % (preferably, <0.01 mol %; more preferably, <0.001 mol %; most preferably, <detectable limit) of structural units of a monoethylenically unsaturated amide containing monomer selected from the group consisting of N-vinylformamide; (meth)acrylamide; 2-acrylamido-2-methyl-propanesulfonic acid (AMPS); 3-(methacrylamide)propyl trimethylammonium chloride (MAPTAC) and mixtures thereof.

Preferably, the thickening polymer of the present invention is biodegradable as determined following the procedure of OECD 302B. More preferably, the thickening polymer of the present invention has inherent, ultimate biodegradability as determined following the procedure of OECD 302B.

The thickening polymer of the present invention can be made using conventional or otherwise known polymerization techniques.

Preferably, the aqueous detergent formulation, of the present invention optionally further comprises providing an additive selected from the group consisting of a builder (e.g., sodium bicarbonate, sodium carbonate, zeolites, sodium citrate, sodium tripolyphosphate and aminocarboxylates (such as methylglycine diacetic acid, sodium salt or glutamic acid diacetic acid, sodium salt)); a filler; an enzyme (e.g., proteases, cellulases, lipases, amylases, mannanases); a pigment; a dye; a structurant; a colorant; a bleaching agent (e.g., sodium percarbonate, sodium perborate, sodium hypochlorite); a bleach activator (tetra acetyl ethylene diamine (TAED)); a stabilizer; a foam control agents (e.g., fatty acids, polydimethylsiloxane); an optical brightener; a hydrotrope (e.g., sodium xylene sulfonate); a fragrance (e.g., essential oils such as D-limonene); a conditioning polymer; a preservative and mixtures thereof.

Preferably, the aqueous detergent formulation of the present invention, further comprises 0 to 10 wt % (preferably, 0.1 to 10 wt %; more preferably, 0.2 to 8 wt %; most preferably, 0.5 to 7.5 wt %), based on the weight of the aqueous detergent formulation, of a hydrotrope. More preferably, the aqueous detergent formulation of the present invention, further comprises 0 to 10 wt % (preferably, 0.1 to 10 wt %; more preferably, 0.2 to 8 wt %; most preferably, 0.5 to 7.5 wt %), based on the weight of the aqueous detergent formulation, of a hydrotrope; wherein the hydrotrope is selected from the group consisting of alkyl hydroxides; glycols; urea; calcium, sodium, potassium, ammonium and alkanol ammonium salts of xylene sulfonic acid, toluene sulfonic acid, ethylbenzene sulfonic acid, naphthalene sulfonic acid and cumene sulfonic acid; salts thereof and mixtures thereof. Still more preferably, the aqueous detergent formulation of the present invention, further comprises 0 to 10 wt % (preferably, 0.1 to 10 wt %; more preferably, 0.2 to 8 wt %; most preferably, 0.5 to 7.5 wt %), based on the weight of the aqueous detergent formulation, of a hydrotrope; wherein the hydrotrope is selected from the group consisting of sodium toluene sulfonate, potassium toluene sulfonate, sodium xylene sulfonate, ammonium xylene sulfonate, potassium xylene sulfonate, calcium xylene sulfonate, sodium cumene sulfonate, ammonium cumene sulfonate and mixtures thereof. Most preferably, the aqueous detergent formulation of the present invention, further comprises 0 to 10 wt % (preferably, 0.1 to 10 wt %; more preferably, 0.2 to 8 wt %; most preferably, 0.5 to 7.5 wt %), based on the weight of the aqueous detergent formulation, of a hydrotrope; wherein the hydrotrope is sodium xylene sulfonate.

Preferably, the aqueous detergent formulation of the present invention, further comprises 0 to 30 wt % (preferably, 1 to 20 wt %; more preferably, 2.5 to 10 wt %), based on the weight of the aqueous detergent formulation, of a builder. More preferably, the aqueous detergent formulation of the present invention, further comprises 0 to 30 wt % (preferably, 1 to 20 wt %; more preferably, 2.5 to 10 wt %), based on the weight of the aqueous detergent formulation, of a builder; wherein the builder is selected from the group consisting of inorganic builders (e.g., tripolyphosphate, pyrophosphate); alkali metal carbonates; borates; bicarbonates; hydroxides; zeolites; citrates (e.g., sodium citrate); polycarboxylates; monocarboxylates; aminotrismethylenephosphonic acid; salts of aminotrismethylenephosphonic acid; hydroxyethanediphosphonic acid; salts of hydroxyethanediphosphonic acid; diethylenetriaminepenta(methylenephosphonic acid); salts of diethylenetriaminepenta(methylenephosphonic acid); ethylenediaminetetraethylene-phosphonic acid; salts of ethylenediaminetetraethylene-phosphonic acid; oligomeric phosphonates; polymeric phosphonates; mixtures thereof. Most preferably, the aqueous detergent formulation of the present invention, further comprises 0 to 30 wt % (preferably, 1 to 20 wt %; more preferably, 2.5 to 10 wt %), based on the weight of the aqueous detergent formulation, of a builder; wherein the builder includes sodium citrate.

Preferably, the aqueous detergent formulation of the present invention, further comprises 0 to 2 wt % (preferably, 0.05 to 0.8 wt %; more preferably, 0.1 to 0.4 wt %), based on the weight of the aqueous detergent formulation, of a structurant. More preferably, the aqueous detergent formulation of the present invention, further comprises 0 to 2 wt % (preferably, 0.05 to 0.8 wt %; more preferably, 0.1 to 0.4 wt %), based on the weight of the aqueous detergent formulation, of a structurant; wherein the structurant is a non-polymeric, crystalline hydroxy-functional materials capable of forming thread like structuring systems throughout the aqueous detergent formulation when crystallized in situ.

Preferably, the aqueous detergent formulation of the present invention, further comprises 0 to 10 wt % (preferably, 0.001 to 5 wt %; more preferably, 0.005 to 3 wt %; most preferably, 0.01 to 2.5 wt %), based on the weight of the aqueous detergent formulation, of a fragrance.

Preferably, the aqueous detergent formulation of the present invention, further comprises 0 to 10 wt % (preferably, 0.5 to 10 wt %), based on the weight of the aqueous detergent formulation, of a conditioning polymer. More preferably, the aqueous detergent formulation of the present invention, further comprises 0 to 10 wt % (preferably, 0.5 to 10 wt %), based on the weight of the aqueous detergent formulation, of a conditioning polymer; wherein the conditioning polymer is a cationic coacervating polymer (e.g., cationic hydroxyl ethyl cellulose; polyquaternium polymers and combinations thereof).

Preferably, the aqueous detergent formulation of the present invention has a pH of 6 to 12.5 (preferably, 6.5 to 11; more preferably, 7.5 to 10). Bases for adjusting pH include mineral bases such as sodium hydroxide (including soda ash) and potassium hydroxide; sodium bicarbonate; sodium silicate; ammonium hydroxide; and organic bases (e.g., mono-, di- or tri-ethanolamine; and 2-dimethylamino-2-methyl-1-propanol (DMAMP)). Acids to adjust the pH include mineral acids (e.g., hydrochloric acid, phosphorus acid and sulfuric acid) and organic acids (e.g., acetic acid).

Preferably, the aqueous detergent formulation of the present invention contains less than 2 wt % (preferably, <1 wt %; more preferably, <0.01 wt %; still more preferably, <0.001 wt %; most preferably, <detectable limit), based on dry weight of the thickening polymer, of a drying oil. More preferably, the aqueous detergent formulation of the present invention contains less than 2 wt % (preferably, <1 wt %; more preferably, <0.01 wt %; still more preferably, <0.001 wt %; most preferably, <detectable limit), based on dry weight of the thickening polymer, of a drying oil selected from the group consisting of safflower oil, linseed oil, castor oil, oiticica oil, sunflower oil, soybean oil, perilla oil, tall oil, dehydrated castor oil, poppy oil, tung oil, very long oil alkyds, long oil alkyds and mixtures thereof.

Some embodiments of the present invention will now be described in detail in the following Examples.

### Syntheses S1-S6: Thickening Polymer

To a glass reactor was charged a mixture of deionized water (65.5 g) and an aqueous solution of lauryl ethoxylated sulfate surfactant (2.4 g, 31 wt % available from BASF under tradename Disponil FES-32). The reactor contents were then heated to 30° C. with stirring. Separately, in a container a monomer emulsion (ME) was prepared by vortex mixing a combination of deionized water (3.4 g), an aqueous solution of sodium vinyl sulfonate (SVS) (1.32 g, 0.24 wt %), an aqueous solution of secondary C₁₃ alkyl ethoxylate (0.23 g, 70 wt % available from the Dow Chemical Company under the tradename Tergitol™ 15-S-40), an aqueous solution of lauryl ethoxylated sulfate surfactant (0.45 g, 31 wt %) and a vinyl alkanoate monomer, A, as identified and in the amount noted in TABLE 1. The vortexed ME was then added to the reactor with continued stirring. The ME container was then rinsed forward into the reactor with deionized water (6 g). After a 5 minute hold, a carboxylic acid functionalized vinyl ester monomer, B, as identified and in the amount noted in TABLE 1 was added to the reactor. A crosslinker, C, if any, as identified and in the amount noted in TABLE 1 was added to the reactor. After a 2 minute hold, an aqueous solution of iron sulfate (1.2 g, 0.015 wt %) was then added to the reactor. After a 1 minute hold, a solution of ammonium persulfate (0.16 g) in deionized water (1.7 g) was added to the reactor. After a 1 minute hold, a sulfur-based formaldehyde free reducing agent (0.212 g, Bruggolite FF6 M available from Bruggemann) in water (3.0 g) was added to the reactor. After 30 minutes, another solution of ammonium persulfate (0.16 g) in deionized water (1.7 g) was added to the reactor. After a 1 minute hold another solution of sulfur-based formaldehyde free reducing agent (0.212 g, Bruggolite FF6 M available from Bruggemann) in water (3.0 g) was added to the reactor. After 15 minutes, the reactor product was then collected for analysis. The pH and weight percent solids of reactor product are reported in TABLE 2.

TABLE 1

| | A | | B | | C | |
|---|---|---|---|---|---|---|
| Synthesis | Monomer | (g) | Monomer | (g) | Crosslinker | (g) |
| S1 | vinyl | 11.5 | vinyl | 4.8 | — | — |
| | acetate | | succinic acid | | | |
| S2 | vinyl | 11.5 | vinyl | 4.8 | diallyl | 0.008 |
| | acetate | | succinic acid | | phthalate | |
| S3 | vinyl | 8.15 | vinyl | 8.15 | dially | 0.008 |
| | acetate | | succinic acid | | phthalate | |
| S4 | vinyl | 8.15 | vinyl | 8.15 | dially | 0.025 |
| | acetate | | succinic acid | | phthalate | |
| S5 | vinyl | 11.5 | vinyl | 4.8 | dially | 0.008 |
| | acetate | | adipic acid | | phthalate | |
| S6 | vinyl | 8.15 | vinyl | 8.15 | dially | 0.008 |
| | acetate | | adipic acid | | phthalate | |

TABLE 2

| Synthesis | pH | solids (wt %) |
|---|---|---|
| S1 | 2.9 | 15.3 |
| S2 | 2.9 | 15.3 |
| S3 | 2.6 | 14.7 |
| S4 | 2.5 | 15.0 |
| S5 | 3.9 | 16.8 |
| S6 | 3.6 | 16.8 |

### Comparative Examples CF1-CF4 and Examples F1-F6: Laundry Detergent

A laundry detergent formulation was prepared in each of Comparative Examples CF1-CF4 and Examples F1-F6 having the recipe noted in TABLE 3. The formulations were prepared by combining ingredients, in the order listed in TABLE 3, while constantly mixing with an overhead mixer to give a vortex. The anionic surfactants, water and solvent were mixed well until all components were incorporated before the, pre-melted at 50° C., nonionic surfactant was added. The pH was then adjusted to 8.5 with a NaOH solution. The thickening polymer, as indicated in TABLE 3, was then added to the formulation while mixing with the overhead mixer in sufficient quantity to provide 1.2 wt % active thickening polymer in the formulation. The pH was adjusted back to 8.5, as necessary, using a NaOH or a HCl solution. Then water was added, as needed, to complete the formulation to 100 wt %.

TABLE 3

| | Example | | | | | | | | | |
|---|---|---|---|---|---|---|---|---|---|---|
| Ingredient | CF1 | CF2 | CF3 | CF4 | F1 | F2 | F3 | F4 | F5 | F6 |
| Water | 19 | 19 | 19 | 19 | 19 | 19 | 19 | 19 | 19 | 19 |
| Linear alkyl | 10.9 | 10.9 | 10.9 | 10.9 | 10.9 | 10.9 | 10.9 | 10.9 | 10.9 | 10.9 |
| benzene | | | | | | | | | | |
| sulfonate¹ | | | | | | | | | | |
| Propylene glycol | 5 | 5 | 5 | 5 | 5 | 5 | 5 | 5 | 5 | 5 |
| Ethanol | 2 | 2 | 2 | 2 | 2 | 2 | 2 | 2 | 2 | 2 |
| Sodium lauryl | 6.7 | 6.7 | 6.7 | 6.7 | 6.7 | 6.7 | 6.7 | 6.7 | 6.7 | 6.7 |
| ethyoxysulfate² | | | | | | | | | | |
| Non-ionic | 8 | 8 | 8 | 8 | 8 | 8 | 8 | 8 | 8 | 8 |
| surfactant³ | | | | | | | | | | |
| NaOH solution | as needed to adjust pH to 8.5 | | | | | | | | | |
| Commercial ASE | — | 6.67 | — | — | — | — | — | — | — | — |
| thickener⁴ | | | | | | | | | | |
| Commercial HASE | — | — | 4.0 | — | — | — | — | — | — | — |
| thickener⁵ | | | | | | | | | | |
| Commercial | — | — | — | 6.66 | — | — | — | — | — | — |
| rheology | | | | | | | | | | |
| modifier⁶ | | | | | | | | | | |
| Product of | — | — | — | — | 7.84 | — | — | — | — | — |
| Synthesis S1 | | | | | | | | | | |
| Product of | — | — | — | — | — | 7.85 | — | — | — | — |
| Synthesis S2 | | | | | | | | | | |
| Product of | — | — | — | — | — | — | 8.16 | — | — | — |
| Synthesis S3 | | | | | | | | | | |
| Product of | — | — | — | — | — | — | — | 8.0 | — | — |
| Synthesis S4 | | | | | | | | | | |
| Product of | — | — | — | — | — | — | — | — | 7.15 | — |
| Synthesis S5 | | | | | | | | | | |
| Product of | — | — | — | — | — | — | — | — | — | 7.15 |
| Synthesis S6 | | | | | | | | | | |

| | |
|---|---|
| NaOH or HCl | as needed to adjust pH to 8.5 |
| solution | |
| Water | q.s. 100 |

¹Nacconal 90G from Stepan Company
²Steol CS-460 from Stepan Company
³Biosoft N25-7 from Stepan Company
⁴ACUSOL ™ 810A rheology modifier from The Dow Chemical Company
⁵ACUSOL ™ 823 rheology modifier from The Dow Chemical Company
⁶ACUSOL ™ 842 rheology modifier from The Dow Chemical Company

### Viscosity of Laundry Detergent Formulations

The viscosity of the laundry detergent formulations prepared according to Comparative Examples CF1-CF4 and Examples F1-F6 were measured with a Brookfield viscometer, using a LV-2 (62) spindle at 3 rpm. The results are provided in TABLE 4.

TABLE 4

| Laundry Detergent Formulation | Viscosity (cP) |
|---|---|
| Comparative Example CF1 | 380 |
| Comparative Example CF2 | 1,560 |
| Comparative Example CF3 | 1,220 |
| Comparative Example CF4 | 1,700 |
| Example F1 | 680 |
| Example F2 | 1,020 |
| Example F3 | 540 |
| Example F4 | 1,040 |
| Example F5 | 1,530 |
| Example F6 | 1,460 |

### Biodegradability

The biodegradability of a thickening polymer prepared according to Synthesis S1 was evaluated according to the inherent aerobic biodegradation test procedure set forth in OECD 302B. The results are provided in TABLE 5.

TABLE 5

| | % biodeg by dissolved organic carbon (DOC) removal at | | | | | | |
|---|---|---|---|---|---|---|---|
| | | | | | Day | Day | Day |
| Latex | Day 0 | Day 1 | Day 7 | Day 14 | 21 | 28 | 35 |
| Synthesis S1 | 0 | 32 | 90 | 91 | 90 | 92 | 93 |

We claim:

1. An aqueous detergent formulation, comprising:
an aqueous carrier;
a cleaning surfactant;
a thickening polymer, comprising:
20 to 80 wt %, based on dry weight of the thickening polymer, of structural units of a monoethylenically unsaturated vinyl alkanoate having 4 to 12 carbon atoms;
20 to 80 wt %, based on dry weight of the thickening polymer, of structural units of a monoethylenically unsaturated carboxylic acid functionalized vinyl ester having 4 to 12 carbon atoms;
0 to 5 wt %, based on dry weight of the thickening polymer, of structural units of a multiethylenically unsaturated crosslinker;
0 to 20 wt %, based on dry weight of the thickening polymer, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; and
wherein the thickening polymer contains less than 10 wt %, based on dry weight of the thickening polymer, of structural units of a monoethylenically unsaturated dicarboxylic acid having 4 to 6 carbon atoms, alkali metal salts thereof, ammonium salts thereof and mixtures thereof.

2. The aqueous detergent formulation of claim 1, wherein the structural units of monoethylenically unsaturated vinyl alkanoate having 4 to 12 carbon atoms and the structural units of monoethylenically unsaturated carboxylic acid functionalized vinyl ester having 4 to 12 carbon atoms account for a total of 70 to 100 wt % of the thickening polymer, based on dry weight of the thickening polymer.

3. The aqueous detergent formulation of claim 2, wherein the structural units of monoethylenically unsaturated vinyl alkanoate having 4 to 12 carbon atoms are selected from the group of structural units consisting of vinyl acetate, vinyl propionate, vinyl butyrate, vinyl isobutyrate, vinyl pentanoate, vinyl 3-methyl butanoate, vinyl pivalate, vinyl hexanoate, vinyl 4-methyl pentanoate, vinyl 3,3-dimethyl butanoate, vinyl heptanoate, vinyl 5-methyl hexanoate, vinyl 4,4-dimethyl pentanoate, vinyl octanoate, vinyl 6-methyl heptanoate, vinyl 5,5-dimethyl hexanoate and mixtures thereof.

4. The aqueous detergent formulation of claim 3, wherein the structural units of monoethylenically unsaturated carboxylic acid functionalized vinyl ester having 4 to 12 carbon atoms are selected from the group of structural units consisting of 4-oxo-4-(vinyloxy)butanoic acid, 5-oxo-5-(vinyloxy)pentanoic acid, 6-oxo-6-(vinyloxy)hexanoic acid, 7-oxo-7-(vinyloxy)heptanoic acid, 8-oxo-8-(vinyloxy)octanoic acid and mixtures thereof.

5. The aqueous detergent formulation of claim 4, wherein the thickening polymer comprises 0.01 to 2.5 wt %, based on dry weight of the thickening polymer, of structural units of the multiethylenically unsaturated crosslinker.

6. The aqueous detergent formulation of claim 5, wherein the multiethylenically unsaturated crosslinker is diallyl phthalate.

7. The aqueous detergent formulation of claim 6, wherein the thickening polymer further comprises 0.1 to 5 wt %, based on dry weight of the thickening polymer, of structural units of the other monoethylenically unsaturated monomer; wherein the other monoethylenically unsaturated monomer is selected from the group consisting of (meth)acrylate, (meth)acrylamide, vinyl ether, vinyl sulfonic acid, styrene sulfonic acid, (meth)acrylic acid, maleic acid, salts thereof and mixtures thereof.

8. The aqueous detergent formulation of claim 7, wherein the structural units of monoethylenically unsaturated vinyl alkanoate having 4 to 12 carbon atoms are structural units of vinyl acetate.

9. The aqueous detergent formulation of claim 8, wherein the structural units of monoethylenically unsaturated carboxylic acid functionalized vinyl ester having 4 to 12 carbon atoms are structural units of 6-oxo-6-(vinyloxy)hexanoic acid; and wherein the other monoethylenically unsaturated monomer is selected from the group consisting of vinyl sulfonic acid, a salt of vinyl sulfonic acid and mixtures thereof.

10. The aqueous detergent formulation of claim 9, further comprising an optional component selected from the group consisting of a builder, a filler, an enzyme, a pigment, a dye, a colorant, a bleaching agent, a bleach activator, a stabilizer, a foam control agents, an optical brightener, a hydrotrope, a fragrance, a preservative and mixtures thereof.
